(19) United States
(12) Patent Application Publication
(10) Pub. No.: US 2007/0143590 A1
(43) Pub. Date: Jun. 21, 2007

(54) SYSTEM AND METHOD FOR SELECTING A FIRST BOOT DEVICE FOR A COMPUTER

(75) Inventor: Ming-Lung Lee, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,459

(22) Filed: Aug. 10, 2006

(30) Foreign Application Priority Data
Dec. 16, 2005 (CN) 200510120688.8

(51) Int. Cl. G06F 15/177

(52) U.S. Cl. 713/2

(57) ABSTRACT

A computer-based method for selecting a first boot device for a computer is provided. The method includes the steps of: initializing a boot menu, and initializing a time value for the boot menu; entering a POST program and displaying the boot menu; decrementing the time value, and clocking the boot menu; restarting the computer from a first boot device which is selected during the time period according to the time value; and saving parameters of the first boot device into a CMOS. A related system is also disclosed.

### FIELD OF THE INVENTION

The present invention is generally related to systems and methods for selecting startup devices for a computer, and more particularly, is related to a system and a method for selecting a first boot device for a computer.

### DESCRIPTION OF RELATED ART

It is well known in the art that when a typical computer is powered on, the computer executes a self test program referred to as power on self test (POST). The program is a basic input/output system (BIOS) that is burned onto a read only memory (ROM) chip. The BIOS provides the computer with a starter mechanism to run the rest of the software from a floppy disk, a hard disk, a compact disk, or a flash memory according to various requirements of a user. Usually, the BIOS is responsible for booting the computer by searching for an operating system in the hard disk, namely in logical drive C, and writing the operating system into an expanded memory standard (EMS) memory.

However, the user may sometimes want to reinstall the operating system, cleanse a computer virus, or perform system maintenance. The computer may need to be started up from the compact disk or the floppy disk, if so, a first boot device of the computer needs to be reconfigured.

Usually, when configuring the first boot device of the computer, the user needs to do a lot of steps: entering into the BIOS setup by selecting a predetermined key when the computer is turned on (usually, this predetermined key is “Del”); selecting the option of “Advanced BIOS Features”, and entering a submenu of “Advanced BIOS Features”; selecting a “First Boot Device” by using directional keys “↑” and “↓”; selecting the first boot device, such as, the compact disk, the floppy disk, or the hard disk as desired through the keys “Page Up” or “Page Down”; returning to main menu of the BIOS; saving the initialization and existing the BIOS setup through the key “F10”.

The method mentioned above is inconvenient. When the computer is powered on, the user must press the key “Del” within a short time period. Otherwise the BIOS will start the operating system through the first boot device configured in the last BIOS setup, and the user needs to restart the computer. It is not only time-consuming, but also very troublesome.

What is needed, therefore, is a system and method for selecting a first boot device for a computer. Using the system and method, the first boot device can be selected through a boot menu that is displayed during the POST program of the computer instead of entering into the BIOS setup, thus decreasing time, and more convenient for the user.

### SUMMARY OF THE INVENTION

A system for selecting a first boot device for a computer is provided in accordance with a preferred embodiment. The system runs on a computer, and includes an initializing module, a starting module, a timing module and a saving module. The initializing module is programmed for initializing a boot menu, and initializing a time value for the boot menu. The starting module is programmed for initiating the boot menu and the time value. The timing module is programmed for clocking the boot menu according to the time value. The saving module is programmed for saving parameters of a first boot device which is selected during the time period according to the time value into a complementary metal-oxide-semiconductor transistor (CMOS).

A computer-based method for selecting a first boot device for a computer is also provided. The method includes the steps of: initializing a boot menu, and initializing a time value for the boot menu; entering a power on self test (POST) program, and displaying the boot menu; decrementing the time value, and clocking the boot menu; restarting the computer from a first boot device which is selected during the time period according to the time value; and saving parameters of the first boot device into a CMOS.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of a hardware infrastructure of a system for selecting a first boot device for a computer in accordance with a preferred embodiment;

FIG. 2 is a schematic diagram illustrating an interface of a boot menu;

FIG. 3 is a flowchart illustrating a method for initializing a boot menu in accordance with a preferred embodiment; and

FIG. 4 is a flowchart illustrating a method for selecting a first boot device for a computer in accordance with a preferred embodiment.

### DETAILED DESCRIPTION OF THE INVENTION

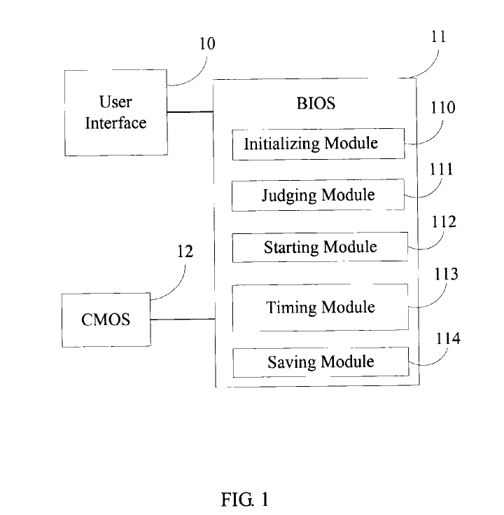

FIG. 1 is a schematic diagram of a hardware infrastructure of a system for selecting a first boot device for a computer (hereinafter “the system”), in accordance with a preferred embodiment. The system runs on a computer (not shown), and typically includes a user interface 10, a BIOS 11, and a CMOS 12. To work, the system may also include a CPU, a motherboard, a memory, and other units or hardware such as a keyboard, a mouse, and so on.

The user interface 10 provides an interface for selecting a first boot device. The BIOS 11 mainly includes an initializing module 110, a judging module 111, a starting module 112, a timing module 113, and a saving module 114.

The initializing module 110 is mainly used for initializing a boot menu and initializing a time value for the boot menu. When the computer is executing a power on self test (POST) program, the boot menu is displayed on the user interface 10 for a time period according to the time value, in order to give time for a user to select the first boot device for the computer.

The judging module 111 is used for determining whether the time value is valid. The initializing range of the time value may be limited to, for example, 0 to 10 seconds. If the time value is initialized to 20 seconds, or with a character that the timing module 113 cannot identify, the time value needs to be initialized once more.

The judging module 111 is further used for: determining whether the boot menu is operative; determining whether the time value has been initialized for the boot menu; determining whether the first boot device is selected within the time period according to the time value; and also determining whether the time value has reached “0”.

Functions of the judging module 111 are described in detail as follows. When the computer is powered on, the judging module 111 determines whether the boot menu is operative. If the boot menu is not operative, the computer executes the POST program normally. Otherwise, if the boot menu is operative, the judging module 111 determines whether the time value for the boot menu has been initialized. If the time value has not been initialized, a default value may be loaded into the time value. When the boot menu is displayed on the user interface 10 while executing the POST program, the judging module 111 determines whether the first boot device is selected during the time period according to the time value. If the first boot device is selected, the computer restarts from the selected first boot device. Otherwise, if no first boot device is selected, the judging module 111 further determines whether the time value has reached “0”. If the time value has reached “0”, the boot menu exits and the computer restarts from the first boot device selected last time.

The starting module 112 is used for initiating the boot menu, and also for decrementing the time value according to real time. When the computer executes the POST program, and if the boot menu is operative, the starting module 112 displays the boot menu on the interface 10 and decrements the time value.

The timing module 113 is used for clocking the boot menu. When the starting module 112 initiates the boot menu and the time value, the timing module 113 begins clocking the boot menu according to the time value. For example, if time value is initialized to 10 seconds, the boot menu displays on the surface 10 for 10 seconds. If the first boot device is selected during the 10 seconds, or no first boot device is selected after the 10 seconds, the boot menu exits automatically.

The saving module 114 is used for saving parameters of the first boot device selected into the CMOS 12.

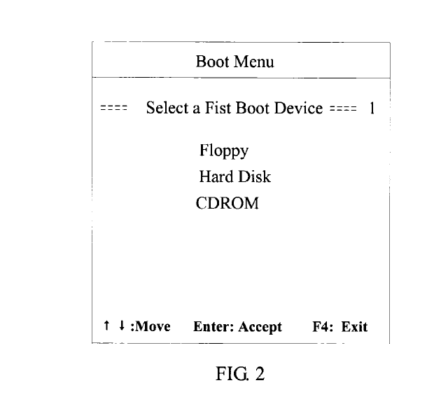

FIG. 2 is a schematic diagram illustrating an interface of a boot menu. A first boot device can be selected from a floppy, a hard disk, or a CDROM according to various requirements of a user. The “1” shown in FIG. 1 means that the remaining time for selecting the first boot device is 1 second. Directional keys “↑” and “↓” are used for selecting the first boot device between the floppy, the hard disk, and the CDROM. The key “Enter” is used for accepting the selected first boot device. The key “F4” is used for exiting the boot menu.

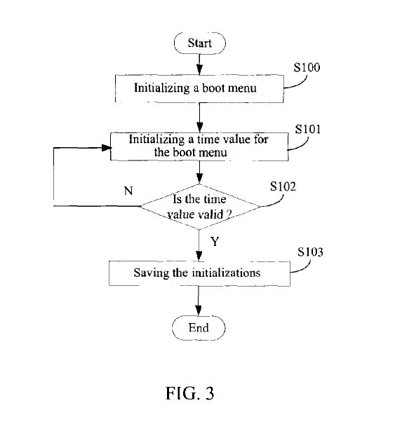

FIG. 3 is a flowchart illustrating a method for initializing the boot menu in FIG. 2, in accordance with a preferred embodiment. In step S100, the initializing module 110 initializes the boot menu. The boot menu initialization may include: initializing options for the user to select the first boot device; in the preferred embodiment, the options are the floppy, the hard disk, and the CDROM; initializing directional keys “↑” and “↓” for selecting the first boot device between the floppy, the hard disk, and the CDROM; initializing the key “Enter” for accepting the selected first boot device; and initializing the key “F4” for exiting the boot menu.

In step S101, the initializing module 110 initializes a time value for the boot menu, and initializes the time value to count down. In step S102, the judging module 111 determines whether the time value is valid. If the time value is invalid, the procedure returns to step S101 described above. Otherwise, if the time value is valid, in step S103, the saving module 114 saves the initializations.

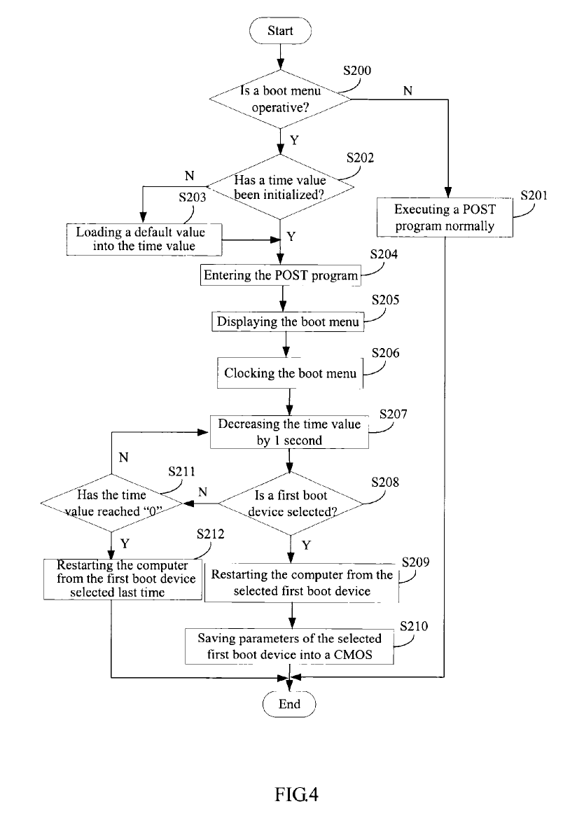

FIG. 4 is a flowchart illustrating a method for selecting a first boot device for a computer by utilizing the boot menu in FIG. 2, in accordance with a preferred embodiment. In step S200, the judging module 111 determines whether the boot menu is operative. If the boot menu is not operative, in step S201, the computer executes a POST program normally. Otherwise, if the boot menu is operative, in step S202, the judging module 111 determines whether the time value of the boot menu has been initialized. If the time value has been initialized, the procedure goes directly to step S204. If the time value has not been initialized, in step S203, the starting module 112 loads a default value into the time value. This default value is 5 seconds.

In step S204, the computer enters the POST program. In step S205, the starting module 112 initiates and displays the boot menu on the user interface 10. In step S206, the starting module 112 decrementing the time value according to real time, and the timing module 113 begins clocking the boot menu according to the time value. In step S207, the timing module 113 decreases the time value by 1 second. In step S208, the judging module 111 determines whether the first boot device is selected and accepted within the time period according to the time value. If the first boot device is selected and accepted, in step S209, the computer restarts from the selected first boot device. In step S210, the saving module 113 saves parameters of the selected first boot device into the CMOS 12.

If, in step S208, no first boot device is selected, the judging module 111 determines if the time value has reached “0”. If the time value has not reached “0”, the procedure turns to step S207 described above, the timing module 113 decreases the time value by 1 second. Otherwise, if the time value has reached “0”, in step S212, the computer restarts from the first boot device selected last time.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for selecting a first boot device for a computer, the system comprising:
an initializing module for initializing a boot menu, and initializing a time value for the boot menu;
a starting module for initiating the boot menu and the time value;
a timing module for clocking the boot menu according to the time value; and
a saving module for saving parameters of a first boot device that is selected during the time period according to the time value.

2. The system according to claim 1, further comprising a judging module for determining if the boot menu is operative.

3. The system according to claim 2, wherein the judging module is further programmed for determining if the time value is initialized.

4. The system according to claim 3, wherein the judging module is further programmed for determining whether the first boot device has been selected and accepted within the time period according to the time value.

5. A computer-based method for selecting a first boot device for a computer, the method comprising the steps of:
initializing a boot menu, and initializing a time value for the boot menu;
entering a POST program, and displaying the boot menu if the boot menu is operative;
decrementing the time value, and clocking the boot menu;
restarting the computer from a selected first boot device if the first boot device is selected and accepted during the time period according to the time value; and
saving parameters of the selected first boot device.

6. The method according to claim 5, further comprising the step of:
starting the computer normally if the boot menu is not operative.

7. The method according to claim 5, further comprising the step of:
loading a default value into the time value if the time value is not initialized.

8. The method according to claim 5, further comprising the step of:
restarting the computer from the first boot device selected last time if no first boot device is selected during the time period according to the time value.
